(19) United States
(12) Patent Application Publication
(10) Pub. No.: US 2006/0289032 A1
(43) Pub. Date: Dec. 28, 2006

(54) Dental floss for treatment of periodontitis

(76) Inventor: Shahla Satary-Ravabakhsh, Fresno, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/513,948

(22) Filed: Aug. 31, 2006

Related U.S. Application Data
(63) Continuation-in-part of application No. 10/695,033, filed on Oct. 27, 2003.

(51) Int. Cl. A61C 15/00

(52) U.S. Cl. 132/321

(57) ABSTRACT

A dental floss comprised of a dental floss strand having one or more medicinal members thereon for retaining and selectively placing a medicine product into the periodontal pocket of a patient afflicted with periodontitis. Preferably, at least a portion of the dental floss strand is made from a dissolvable material and the medicinal members comprise a spongy or absorbent material. The medicine product is an antimicrobial agent, preferably of the tetracycline family of medicines, such as the gelled form of doxycycline hyclate. A pair of separatable segment areas are positioned on either side of each medicinal member. The user utilizes the floss to place the medicinal member in the periodontal pocket and then separates the portion of the strand having medicinal member from the strand. The medicine product releases into the periodontal pocket, where it treats the periodontitis, as the strand dissolves.

### CROSS-REFERENCE TO RELATED APPLICATIONS

This patent application is a continuation-in-part of U.S. patent application Ser. No. 10/695,033 filed Sep. 3, 2003, now abandoned.

### BACKGROUND OF THE INVENTION

A. Field of the Invention

The field of the present invention relates generally to dental flosses used for removing unwanted material trapped between the teeth and/or between the teeth and gums. More specifically, the present invention relates to an improved dental floss that is adapted to deliver antibiotic or other medicine into the pockets between the gum and teeth. Even more specifically, the present invention relates to dental floss that has one or more sections of absorbent material for carrying medicine to treat periodontitis and related diseases.

B. Background

Good dental hygiene is known to be important for an individual's overall good health. Despite this, for various social, economic, psychological and physiological reasons, not everyone has the benefit of good dental health. One of the more common and serious dental health problems is a serious gum disease known as Adult Chronic Periodontitis, generally referred to a periodontitis or periodontal disease. Periodontitis is characterized by a loss of supporting tissues of the teeth that forms deep pockets (commonly referred to as periodontal pockets) around the teeth. This condition is believed to begin with the formation of plaque about the teeth and/or entrapment of food particles between the teeth, which results in an accumulation of certain microorganisms that are able to exist in the anaerobic microenvironment of the periodontal pockets. It is believed that the growth of the microorganisms, which are clinically found in plaque buildup, produce toxic acidity products which reabsorbs bone tissue from around the tooth. The more the bone is absorbed, the deeper the periodontal pocket gets, which has the cyclical effect of entrapping more food particles and encouraging growth of microorganisms that causes periodontitis. Eventually, the periodontal pocket increases in size such that the tooth becomes substantially unsupported, loose and ultimately the patient loses the effected tooth or teeth.

It is well known that routine and thorough removal of plaque and entrapped food particles from around the teeth significantly lowers the likelihood of periodontitis. Although brushing with conventional toothbrushes is strongly encouraged for good dental hygiene, brushing alone is generally considered inadequate to remove all of the entrapped food particles and any plaque build-up that exists. It is also known that once periodontitis starts, brushing alone will not cure or significantly reverse the effects of the periodontal disease. Instead, it has been highly recommended for many years that patients utilize dental floss to clean the area low on the teeth between the gums and the teeth to remove entrapped food particles and plaque. Most dentists strongly recommend that their patients routinely utilize dental floss to clean the otherwise hard-to-reach areas between the teeth and at the base of the teeth.

Although many types of dental floss are available, the two main categories of dental floss are multi-filament and tapes. In general, dental floss is configured to have a relatively low coefficient of friction that allows it to easily pass between adjacent teeth. The most common type of dental floss are the multi-filament type. Dental floss has been known to come coated with wax, flavorants and medicaments, including fluorides, anti-bacterial agents, antibiotics, anti-plaque agents, anti-tar agents and polishing agents. To improve the user's grip of the dental floss and better remove materials from between the teeth and plaque buildup on the teeth, some dental floss has been provided with spaced apart spherical protuberances, as exemplified by U.S. Pat. No. 6,112,753 to Arsenault, and with a plurality of abrasive particles integrated into the individual monofilaments that make up the floss string, as exemplified by U.S. Pat. No. 6,453,912 to Antler. It has also been known to incorporate small titanium dioxide particles into the dental floss as a whitening and cleaning agent, along with fluoride based compounds to reduce the incidence of dental decay, as exemplified by U.S. Pat. No. 6,102,050 Marcon.

Once periodontitis sets in, the dentist first removes the plaque and calculus from the root surface, a process commonly referred to as scaling and root planing. This debridement of the root surface from plaque and calculus is normally done on patients who have periodontal pocket depths of 5 mm or greater. After this process, the goal is to maintain the periodontal pocket clean, kill the microorganisms and try to reduce the pocket depth so as to achieve some clinical attachment of soft tissue to healthy roots, which has the affect of automatically decreasing bleeding. To destroy the remaining bacteria at the severely infected areas, antibiotics are generally prescribed. Presently, the preferred drugs of choice are tetracycline family of medicines. If the above is not entirely successful, such that the periodontal pocket depth keeps increasing or the bleeding and/or inflammation does not stop, periodontal surgery is typically the next recommended procedure.

In recent years, a number of new therapies have been developed to treat periodontitis and maintain the periodontal pocket free of germs. One of these is the use of Arestin™ from OraPharma, Inc., which is a powder form of minocycline 1-mg, which is a branch of the tetracycline family. A syringe-type of device is utilized to deposit the medicine in the periodontal pocket to shrink the periodontitis. Another new therapy is the use of Atridox® from Collagenex Pharmaceuticals, which is a gel form of the antimicrobial doxycycline hyclate, which is also in the tetracycline family. A syringe-type device deposits the antimicrobial gel into the periodontal pocket, where it is intended to flow throughout the pocket, to reduce pocket depth and decrease bleeding. Another new therapy is the PerioChip® form Astra Pharmaceuticals, L.P., which is a small chip-like object that is inserted into the periodontal pocket to release the antibiotic chlorhexidine under the gum at the sides of the pocket. The primary goal of the above treatment methods is to place an antimicrobial agent into the periodontal pocket in order to destroy any remaining gems. In addition, these methods do not have some of the problems associated with the side effects of taking the necessary medicine orally, which can generally only be taken for a limited time period despite the fact that periodontal disease is not usually cured with a one time treatment. One of the primary disadvantages of the above-described methods is that they need to be performed in a dental office by a dentist or a trained dental technician. Another disadvantage is the cost of the treatment methods. These disadvantages are compounded by the fact that periodontal problems most often occur in people who are either too scared to go to the dentist regularly or have limited income available for dental visits.

What is needed, therefore, is an apparatus and method of allowing the individual patient to easily and effectively deliver the necessary antimicrobial agent(s) to the periodontal pocket to reduce pocket depth and the bleeding associated with periodontitis. Because it is well known that flossing is effective at reducing plaque buildup and removing particulate matter and flossing is something that people can do relatively inexpensively at home, an improved dental floss that incorporates a delivery mechanism for antimicrobial agents would be very beneficial to the typical person suffering from periodontal disease. The desired dental floss would either be provided with the antimicrobial agent or the user could apply the desired agent to dental floss such that when he or she flosses, a quantity of the agent will be placed in the periodontal pocket to provide the benefits discussed above. Preferably, the improved dental floss would be adaptable for use with presently available microbial agents and comprise medicinal members on separatable sections of floss that dissolve in the user's mouth as the periodontitis is treated. It is also preferred that such an apparatus should be relatively inexpensive to manufacture and simple to utilize.

### SUMMARY OF THE INVENTION

The dental floss for treatment of periodontitis of the present invention solves the problems and provides the benefits identified above. That is to say, the present invention discloses an improved dental floss that is particularly configured to place antimicrobial agents in the periodontal pocket area so as to treat the gum for periodontitis. The improved dental floss of the present invention can be of any variety of dental floss and adaptable to receive a variety of different types of antimicrobial agents. In the preferred embodiment, the improved dental floss is used in the same manner in which presently available dental flosses are utilized. The improved dental floss of the present invention can be made very economically, can be done by the user at his or her own home and is effective at delivering the desired antimicrobial agent to the affected area.

For purposes of this disclosure, the term “dental floss” includes the string or thread-like dental flosses, such as the multi-filament dental flosses, and dental tapes, as well as any other similar or like articles. The dental floss used in the present invention can include any suitable or commercially available dental floss. The dental floss used herein can be fabricated from either natural or synthetic sources, examples of which include, but are not limited to, filaments or yarns of high and normal tenacity polymers, nylon, rayon, dacron, acrylic, acetate polymers, polypropylene, polyethylene and other plastics, alone or in various suitable combinations. Natural substances may include, but are not limited to, cotton, wool, silk, linen and other staple fibers, alone or in various combinations. Blends of synthetic/natural fibers can also be utilized. In general, however, synthetic filaments, particularly multi-filament materials, are preferred as being more durable, typically less expensive and more often easier to use (i.e., a lower coefficient of friction). Dental floss also includes those dental flosses that have or are adapted to have one or more sweetening and/or flavoring agents, including natural and artificial compounds and combinations thereof, that provide improved taste to the dental floss to improve its consumer appeal. Dental floss also includes those dental flosses that are colored or otherwise modified to improve their general consumer appeal.

In one aspect of the present invention, the improved dental floss for treatment of periodontitis comprises an elongated dental floss strand having one or more medicinal members thereon that are configured to have or have a medicine product that is clinically suitable for treatment of the patient's periodontitis. The medicinal members should be configured to be able to retain and selectively release the medicine product into the one or more periodontal pockets when the patient uses the dental floss to floss that portion of his or her mouth. In the preferred embodiment, the medicine product is an antimicrobial agent and, even more preferably, an antimicrobial agent such as tetracycline medicine. A preferred medicine product is the gelled form of doxycycline hyclate. The medicinal members can be at least one spongy member, such as a sponge or sponge-like material, or an absorbent strip made from cotton, cloth or other absorbent materials. Preferably, the medicinal members are disposed on a dissolvable strand of floss that have a pair of segment areas on each side thereof to break off the medicinal member in the periodontal pocket where it treats the gums as the strand dissolves. In the preferred embodiment, the strand is made from polyglycolic acid or polyglactic acid. In use for treating a patient with periodontitis, the manufacturer will supply a dental floss having an elongated dental floss strand with one or more medicinal members on the dental floss strand. The one or more medicinal members can be supplied with a medicine product suitable for treatment of the periodontitis or be adaptable for receiving such a product (i.e., placed thereon by the patient or someone on his or her behalf). The medicinal members must be configured to place the medicine product into the patient's periodontal pockets. The patient breaks off the medicinal member at the segment areas and leaves it in the periodontal pocket where the medicine treats the gums as the floss strand dissolves.

Accordingly, the primary objective of the present invention is to provide an improved dental floss and method of treating periodontitis that provides the advantages discussed above and that overcomes the disadvantages and limitations associated with presently available dental floss and methods of treating periodontitis.

It is also an important objective of the present invention to provide an improved dental floss that incorporates one or more absorbent medicinal members along the length of the dental floss that contain or which are adaptable for receiving microbial agents and dispensing those agents into the periodontal pocket during flossing.

It is also an important objective of the present invention to provide an improved dental floss that includes one or more absorbent medicinal members that contain or which can receive doxycyline hyclate (10%) or other microbial medicine.

It is also an important objective of the present invention to provide an improved dental floss that includes medicinal members, which contain a microbial medicine, on a dissolvable strand of floss bordered by a pair of separatable segments that are configured to break off in the periodontal pocket to treat the periodontitis as the strand of floss dissolves.

It is also an important objective of the present invention to provide an improved method of treating periodontitis that utilizes a dental floss having one or more sections of absorbent material which contains a microbial medicine that is transferred to the periodontal pocket during flossing by the user and which can be accomplished by him or her at the home or other non-dental office locations.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the best modes presently contemplated for carrying out the present invention:

FIG. 1 is a side view of an improved dental floss configured according to one embodiment of the present invention;

FIG. 2 is a side view of an improved dental floss configured according to an alternative embodiment of the present invention;

FIG. 3 is a flow chart showing use of the improved dental floss of the present invention to treat periodontitis; and

FIG. 4 is a side view of an improved dental floss having a plurality of medicinal members on dissolvable strand portions bordered by separatable segment areas.

### DETAILED DESCRIPTION OF THE PREFERRED EMBODIMENTS

With reference to the figures where like elements have been given like numerical designations to facilitate the reader's understanding of the present invention, and particularly with reference to the embodiments of the improved dental floss for treatment of periodontitis of the present invention illustrated in the figures, the preferred embodiments of the present invention are set forth below. The enclosed figures and drawings are merely illustrative of the preferred embodiments and represent several different ways of configuring the present invention. Although specific components, materials, configurations and uses of the present invention are illustrated and set forth in this disclosure, it should be understood that a number of variations to the components and to the configuration of those components described herein and in the accompanying figures can be made without changing the scope and function of the invention set forth herein.

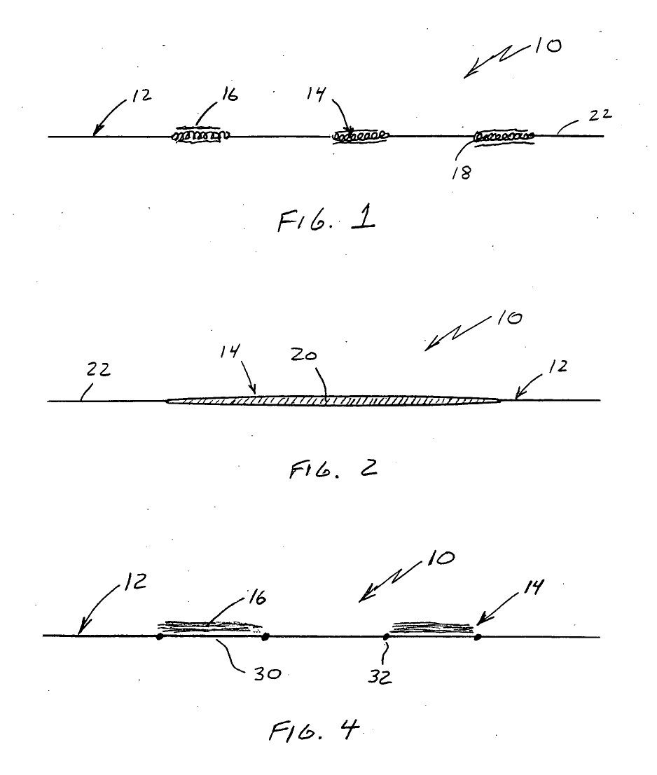

The improved dental floss of the present invention, identified generally as 10 in FIGS. 1 and 2, is comprised of an elongated dental floss strand 12 having one or more medicinal members 14 thereon. Dental floss strand 12 is comprised of dental floss, as defined above, that is suitable for being placed between two adjacent teeth and between a tooth and its adjoining gum to remove plaque and any particulate matter, such as entrapped food particles, that may be located between adjacent teeth or in the periodontal pockets adjacent a tooth. As known to those skilled in the art, the length, diameter, structure or design of the dental floss itself, is not limited to any specific size, shape, arrangement or configuration, and thus, can be fabricated to suit any specific intention. It can, for example be composed of a plurality of individual filaments that have been formed together to give a larger thread having a sufficiently small diameter to permit insertion between the teeth. The dental floss can also comprise a composite multi-filament yarn bonded to an extruded monofilament or to another multi-filament yarn. A single monofilament thread is also useful for the dental floss of the present invention. Other suitable variations are also well known in the art and, as such, are also useable in the invention disclosed herein.

Medicinal members 14 can be any of a variety of available materials suitable for receiving, retaining and dispensing a medicine product, shown generally as 16 in FIGS. 1 and 2, suitable for treating periodontitis and related dental diseases. As shown in FIGS. 1 and 2, one or more medicinal members 14 can be placed along dental floss strand 12 such that the user can utilize the dental floss strand 12 portion of dental floss 10 in the typical way dental floss is utilized to remove plaque and particulate matter from between the teeth and between the teeth and gums. As explained in more detail below, the medicinal members 14 portion of dental floss 10 is utilized to treat the areas of periodontitis. In one configuration, shown in FIG. 1, medicinal members 14 comprise one or more individual spongy members 18 made out of a sponge or sponge-like, generally absorbent material on which a quantity of medicine product 16 can be or is placed. In the preferred embodiment, a plurality of spongy members 18 are included along the length of dental floss strand 12. Natural and synthetic sponge materials may be used for spongy members 18. In another configuration, shown in FIG. 2, medicinal member 14 comprises one or more thin absorbent strips 20 that contain or are configured to contain medicine product 16. Absorbent strips 20 can be made out of cloth, cotton or various other natural or synthetic materials which can suitably retain medicine product 16 until the user utilizes dental floss 10 to clean his or her teeth and apply the medicine product 16 to the periodontal pocket(s) needing attention. As generally known in the art, medicinal members 14 can be affixed to the outer surface 22 of dental floss strand 12 or incorporated within dental floss strand 12, particularly for the multi-filament types of dental floss strands. As further known in the art, dental floss 10 can be provided in long sections that are rolled or otherwise collected inside a container and then cut or broken into smaller sections prior to use or it can be provided in a plurality of individual relatively short lengths suitable for single use.

Medicine product 16 is of the type suitable for treating periodontitis so as to reduce the size of the periodontal pocket and reduce the bleeding typically associated with periodontitis. Generally, the preferred medicine product is a antimicrobial agent that sufficiently destroys the microorganisms that tend to thrive in the anaerobic environment of the periodontal pocket. The preferred antimicrobial agent is tetracycline and the tetracycline family of medicines and, more specifically, docycycline hyclate. These materials can be supplied in various forms that are suitable for use with dental floss 10 of the present invention. For instance docycycline hyclate 10%, used in the Atridox® product discussed above is available in a gel form which can be spread on or over medicinal members 14. In one configuration, dental floss 10 is “pre-loaded” with medicine product 16 by the manufacturer of dental floss 10. In another configuration, medicinal members 14 are provided in a substantially dry form with the user, or someone on his or her behalf, spreading the medicine product 16 on medicinal members 14 immediately prior to use.

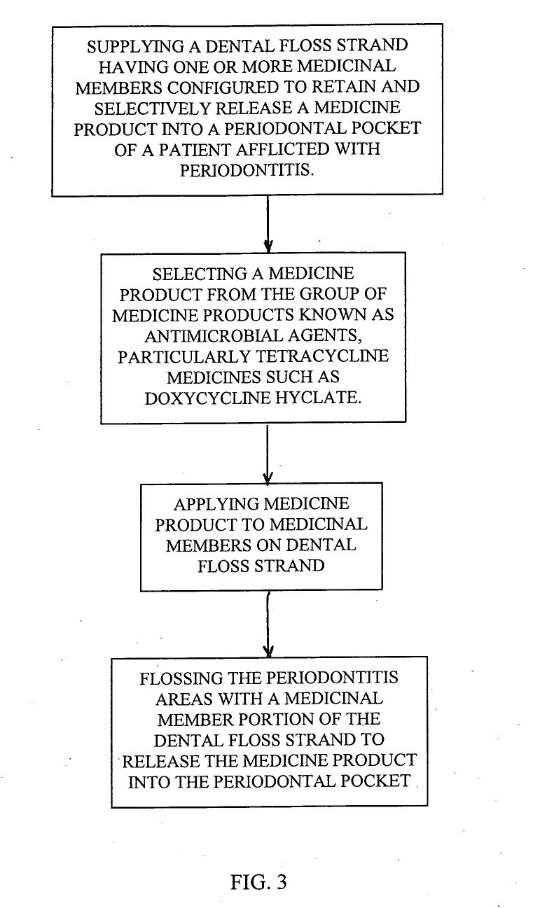

In use, as summarized in the flow chart of FIG. 3, the user would floss the healthy side of his or her teeth using dental floss strand 12 and would floss that area or areas of the mouth where he or she has deep periodontal pockets with the medicinal member 14 portion of dental floss 10. By squeezing and rubbing the medicated medicinal member 14 portions of dental floss 10 around the affected teeth and gum at the deep periodontal pockets, the antimicrobial medicine product 16 will be released. Once released, medicine product 16 will penetrate the tissue and kill the germs that cause the periodontitis. After using dental floss 10, the user should wash or rinse his or her mouth so the medicine product 16 does not stay on the treated area, where it can cause sensitivity problems. The frequency of utilizing the dental floss 10 and the gentleness of the medicine product 16 will keep the periodontal pocket clean. This can lead to tissue re-attachment, which is the ultimate goal of periodontal treatment. Although the user can use dental floss 10 of the present invention to treat his or her periodontitis at home or other places away from the dental office, the diagnosis of periodontitis and the initial instructions regarding use of dental floss 10 should be made by dentists, hygienists and other trained persons.

As can be seen from the above description, a number of benefits derive from the availability of dental floss 10 of the present invention. For instance, the patient can purchase the dental floss 10 him or herself and can apply the treatment to the affected periodontal areas without having to go to the dentists office for each treatment. Due to the ease of use and relatively safety of the treatment method and medicinal product, the patient can utilize dental floss 10 routinely, such as two or three, or more frequently, times a day. This will help keep the periodontal pocket clean and less contaminated. Another advantage of the present invention is that it is somewhat less expensive than other methods of treating periodontitis. Another advantage is the low doses of medicine product 16 used on dental floss 10, which reduces the likelihood of the patient having problems with the medicine product 16. If he or she does have problems, it is easy to stop use of the dental floss 10 so as to stop exposure to the medicine product 16, which is difficult to achieve when using the medicine systemically.

In a preferred embodiment of the dental floss 10 of the present invention, the dental floss or a portion thereof is made from a material that is dissolvable in the human body, such as polyglycolic acid and polyglactic acid (commonly known by their trade names Dexon™ and Vicryl™, respectively) that are presently utilized for sutures. In one configuration of this embodiment, the entire dental floss strand 12 is made from these materials with the medicinal members 14 disposed thereon. In another configuration, shown in FIG. 4, a strand portion 30 of dental floss strand 12 is made from these materials with the medicinal members 14 located on the strand portions 30. In this configuration the preferred medicine product 16 is doxycycline hyclate, which solidifies as soon as it is exposed to human saliva. As known in the art, the polyglycolic acid and polyglactic acid materials are braided and provided in varying thicknesses, with the larger sizes being polyligmented, and is suitable for being dyed for medical purposes. In addition to being dissolvable, these materials are known to cause minimal tissue reaction. In a preferred embodiment, the strand portion 30 is made by providing a thickened area of the dental floss strand 12 and by dying it a separate color than the rest of the dental floss strand. Preferably, the strand portion 30 is bordered at its ends by a pair of segment areas 32, which can be areas of reduced thickness, that are suitable for relatively easily breaking off strand portion 30 from the remaining dental floss strand 12. In this manner, the strand portion 30 with the doxycycline hyclate thereon can be broken off and left inside the patient's periodontal pocket for the medicine to slowly release over time, such as seven days, while the strand portion 30 dissolves in the periodontal pocket. As such, the dental floss strand 12 is being utilized as a delivery system to place the doxycycline hyclate medicine 16 to the periodontal pocket without the need for injection by syringe. Unlike regular flossing, both the medicine product 16 and the strand portion 30 stay under the patient's gums for an extended period of time, with the absorbability of the strand portion 30 prolonging the effect of the doxycycline hyclate medicine 16. In use, the patient is supplied with a dental floss 10 configured as described above, namely with doxycycline hyclate medicine 16 on the dissolvable strand portions 30 separated from dental floss strand 12 by segment areas 32, to treat his or her periodontal pocket problem in a non-injection manner. The patient places the medicinal member 14 on strand portion 30 in the periodontal pocket and then separates the strand portion 30 from the dental floss strand 12 to dispose the strand portion 30, with the doxycycline hyclate medicine 16 thereon, in the periodontal pocket. The patient then allows the medicine 16 to solidify so that it may release the medicine over time and to allow the strand portion 30 to dissolve in the periodontal pocket. In this manner the patient is able to treat his or her periodontal pocket without the need to go to the dental office and, therefore, treat their periodontitis on a more regular basis.

While there are shown and described herein certain specific alternative forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to the dimensional relationships set forth herein and modifications in assembly, materials, size, shape and use.

What is claimed is:

1. A dental floss for treatment of periodontitis in a patient having one or more periodontal pockets, said dental floss comprising:
an elongated dental floss strand; and
one or more medicinal members on said dental floss strand, said one or more medicinal members having a medicine product suitable for treatment of said periodontitis, said medicine product comprising doxycycline hyclate, said one or more medicinal members configured for retaining and selectively placing said medicine product into said one or more periodontal pockets.

2. The dental floss according to claim 1, wherein said dental floss strand is made from a dissolvable material configured to dissolve in said periodontal pockets and said dental floss strand is configured to dispose one of said medicinal members in one of said periodontal pockets.

3. The dental floss according to claim 2, wherein said dental floss strand comprises a pair of segment areas around each of said medicinal members, said segment areas configured to separate said medicinal member from said dental floss stand and dispose said medicinal member in said periodontal pocket.

4. The dental floss according to claim 1, wherein said dental floss strand comprises a pair of segment areas around each of said medicinal members, said segment areas configured to separate said medicinal member from said dental floss stand and dispose said medicinal member in said periodontal pocket.

5. The dental floss according to claim 1, wherein said dental floss strand is made from a material selected from the group comprising polyglycolic acid and polyglactic acid.

6. The dental floss according to claim 1, wherein said one or more medicinal members comprises at least one spongy member.

7. The dental floss according to claim 1, wherein said one or more medicinal members comprises at least one absorbent strip.

8. A dental floss for treatment of periodontitis in a patient having one or more periodontal pockets, said dental floss comprising:
an elongated dental floss strand, at least a strand portion of said dental floss strand made from a dissolvable material configured to dissolve in said periodontal pockets;
one or more medicinal members on strand portion of said dental floss strand, said dental floss strand configured to dispose one of said medicinal members in one of said periodontal pockets, said one or more medicinal members having doxycycline hyclate thereon, said one or more medicinal members configured for placing said doxycycline hyclate into said one or more periodontal pockets; and
a pair of segment areas around each of said medicinal members, said segment areas configured to separate said medicinal member from said dental floss stand and dispose said medicinal member and said strand portion in said periodontal pocket.

9. The dental floss according to claim 8, wherein said strand portion is made from a material selected from the group comprising polyglycolic acid and polyglactic acid.

10. The dental floss according to claim 8, wherein said one or more medicinal members comprises at least one spongy member.

11. The dental floss according to claim 8, wherein said one or more medicinal members comprises at least one absorbent strip.

12. A method of treating periodontitis in a patient having one or more periodontal pockets, said method comprising the steps of:
a) supplying a dental floss having an elongated dental floss strand with one or more medicinal members on said dental floss strand, at least a strand portion of said dental floss strand made from a dissolvable material configured to dissolve in said periodontal pockets, said strand portion having a segment area on each end thereof configured to separate said strand portion from said dental floss strand, a medicinal member on said strand portion, said medicinal member having a medicine product thereon suitable for treatment of said periodontitis, said one or more medicinal members configured for placing said medicine product into said one or more periodontal pockets;
b) placing said medicinal member in one of said periodontal pockets in the patient's mouth with said dental floss strand;
c) separating said strand portion from said dental floss strand to dispose said strand portion in said periodontal pocket; and
d) allowing said doxycycline hyclate to solidify in said periodontal pocket and said strand portion to dissolve in said periodontal pocket.

13. The method of claim 12, wherein said medicine product is an antimicrobial agent.

14. The method of claim 13, wherein said antimicrobial agent is a tetracycline medicine.

15. The method of claim 14, wherein said antimicrobial agent is doxycycline hyclate.

16. The method of claim 15, wherein said strand portion is made from a material selected from the group comprising polyglycolic acid and polyglactic acid.

17. The method of claim 12, wherein said strand portion is made from a material selected from the group comprising polyglycolic acid and polyglactic acid.

18. The method of claim 12, wherein said one or more strand portions are thickened areas of said dental floss strand.

19. The method of claim 12, wherein said one or more medicinal members comprises at least one spongy member.

20. The method of claim 12, wherein said one or more medicinal members comprises at least one absorbent strip.
